(19) United States
(12) Patent Application Publication
(10) Pub. No.: US 2023/0249258 A1
(43) Pub. Date: Aug. 10, 2023

(54) PART ENHANCEMENT SECTIONS FOR 3D PARTS

(71) Applicant: Hewlett-Packard Development Company, L.P., Spring, TX (US)

(72) Inventors: Vladek Kasperchik, Corvallis, OR (US); Jennifer L. Wu, Corvallis, OR (US)

(73) Assignee: Hewlett-Packard Development Company, L.P., Spring, TX (US)

(21) Appl. No.: 18/013,450

(22) PCT Filed: Jul. 31, 2020
(86) PCT No.: PCT/US2020/044619

§ 371 Date: Dec. 28, 2022

(51) Int. Cl. B22F 10/85; B22F 10/14; B33Y 30/00; B33Y 50/02

(52) U.S. Cl. CPC B22F 10/85; B22F 10/14; B33Y 30/00; B33Y 50/02

(57) ABSTRACT

According to examples, an apparatus may include a processor that may generate first print control data that may include instructions to deposit a binding liquid onto selected areas in an upper set of layers of build material particles. The processor may also determine areas in a lower set of layers of build material particles at which a non-binding liquid that does not include the binder to be deposited to define sections of a part enhancement section, the lower set of layers being within a predefined distance below the upper set of layers, in which the areas in the lower set of layers are based on the areas in the upper set of layers of build material particles at which the sections of the part are to be defined. The processor may further generate second print control data corresponding to the determined areas in the lower set of layers.

### BACKGROUND

In three-dimensional (3D) printing, an additive printing process may be used to make 3D solid parts from a digital model. 3D printing techniques are considered additive processes because they involve the application of successive layers or volumes of a build material, such as a powder or powder-like build material, to an existing surface (or previous layer). 3D printing often includes solidification of the build material, which for some materials may be accomplished through use of heat, a chemical binder, and/or an ultra-violet or a heat curable binder.

### BRIEF DESCRIPTION OF THE DRAWINGS

Features of the present disclosure are illustrated by way of example and not limited in the following figure(s), in which like numerals indicate like elements, in which:

FIG. 1 shows a block diagram of an example apparatus that may generate first print control data for defining a 3D part using a binding liquid including a hinder and second print control data for defining a part enhancement section using a non-binding liquid;

FIG. 2 shows an example 3D fabrication system that may define a 3D part according to the first print control data and may define the part enhancement section according to the second print control data;

FIGS. 3A and 3B, respectively, depict cross-sectional side views of a build volume of the 3D fabrication system depicted in FIG. 2 during two example states in the defining of a part enhancement section and the fabrication of a 3D part;

FIG. 4 depicts a flow diagram of an example method for generating first print control data for defining a 3D part using a binding liquid including a binder and second print control data for defining a part enhancement section using a non-binding liquid that does not include a binder; and

FIG. 5 shows a block diagram of an example computer-readable medium that may have stored thereon computer-readable instructions for generating first print control data for defining a 3D part using a binding liquid including a binder and second print control data for defining a part enhancement section using a non-binding liquid that does not include a binder.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Disclosed herein are apparatuses, 3D fabrication systems, and methods in which a processor may generate first print control data including instructions for a part to be defined in an upper set of build material layers using a binding liquid. The binding liquid may include a binder that is to bind the build material particles on which the binding liquid is deposited. The processor may also generate second print control data including instructions for a part enhancement section to be defined in a lower set of build material layers using a non-binding liquid that does not include a binder (i.e., the non-binding liquid is not to bind the build material particles on which the non-binding liquid is deposited). The build material particles in the part enhancement section may thus not be binded or joined together. Instead, the non-binding liquid may be deposited onto the build material particles in the part enhancement section to cause those build material particles to be wetted, which may improve properties, e.g., reduce surface irregularities, of a bottom surface of the part. Although particular reference is made herein to a first print control data and a second print control data, it should be understood that the first print control data and the second print control data may be the same or a common print control data such that, for instance, the first print control data and the second print control data may be part of or include the same set of instructions.

In some instances, when a liquid is deposited through jetting onto dry powder, surface irregularities may occur on the first few layers of the dry powder. After the liquid is deposited onto the first few layers, powder wetting interactions may become less erratic and the number of surface irregularities may diminish in additional layers upon which the liquid is deposited. This may occur due to interactions caused by the liquid deposited in the first few layers with the liquid deposited in the additional layers. As a result, the first few layers at which sections of a part may be defined may have surface irregularities as the initial layers are normally dry or nearly dry when the liquid is applied to those layers while the subsequent layers may not have the irregularities.

According to examples of the present disclosure, to reduce or prevent the formation of the surface irregularities in the bottom section of the part, the part enhancement section may be defined in some of the build material layers that are beneath, e.g., within a predefined distance below, the upper set of layers at which the part is to be defined. The predefined distance may be a certain number of build material layers, which may include no layers, and may be sufficiently small to cause a reduction or elimination of the surface irregularities in the bottom of the part.

In any regard, the part enhancement section may reduce or prevent the formation of the surface irregularities due to a crosstalk effect between a freshly-spread dry powder layer and a layer upon which the non-binding liquid has been deposited. In addition, or alternatively, the previously patterned layers may contain volatile components of liquid formulation jetted onto the powder (water, solvent, surfactants with measurable vapor pressure). The volatile component vapors may percolate upward from the part enhancement section and into the initial layers of the first set of build material layers as the part enhancement section may be defined in layers that are below the layers at which the part may be defined. The percolating vapors and/or solvents may pretreat the initial layers, which may precondition the build material particles for improved wetting. The improved infiltration of the liquid droplets into the vapor-preconditioned initial layers may prevent coagulation of the liquid droplets on the initial layers and may minimize surface irregularities in the bottom section of the part.

Before continuing, it is noted that as used herein, the terms “includes” and “including” mean, but is not limited to, “includes” or “including” and “includes at least” or “including at least.” The term “based on” means “based on” and “based at least in part on.”

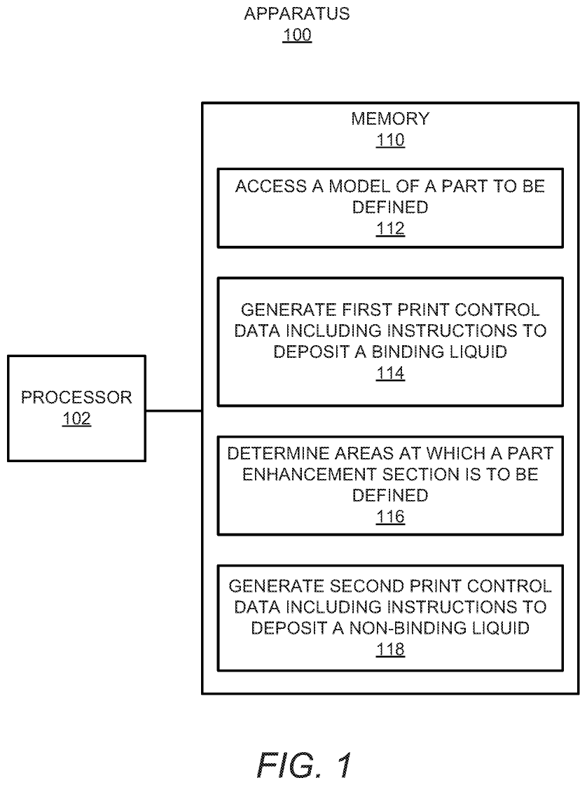

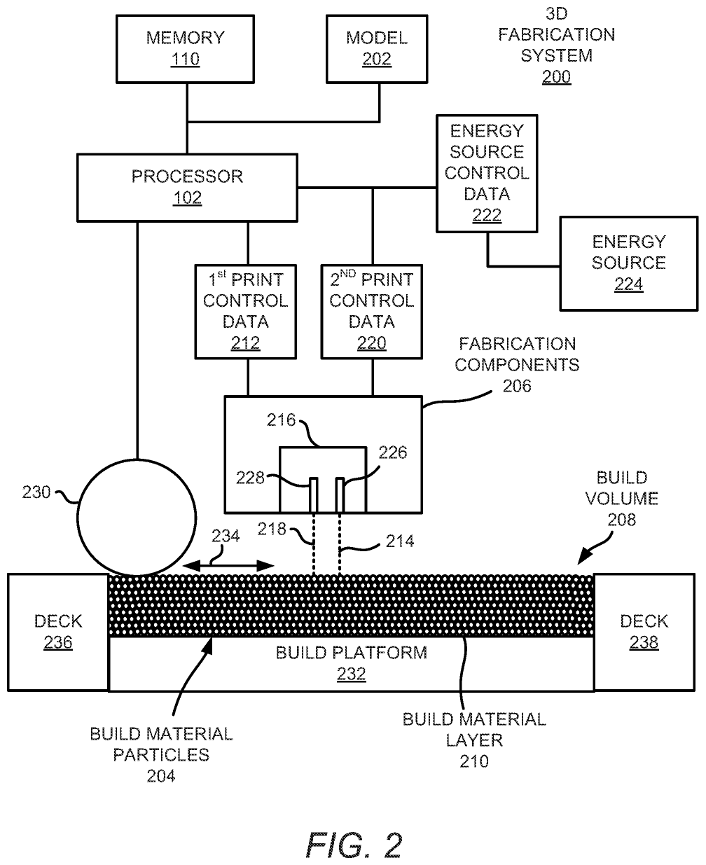

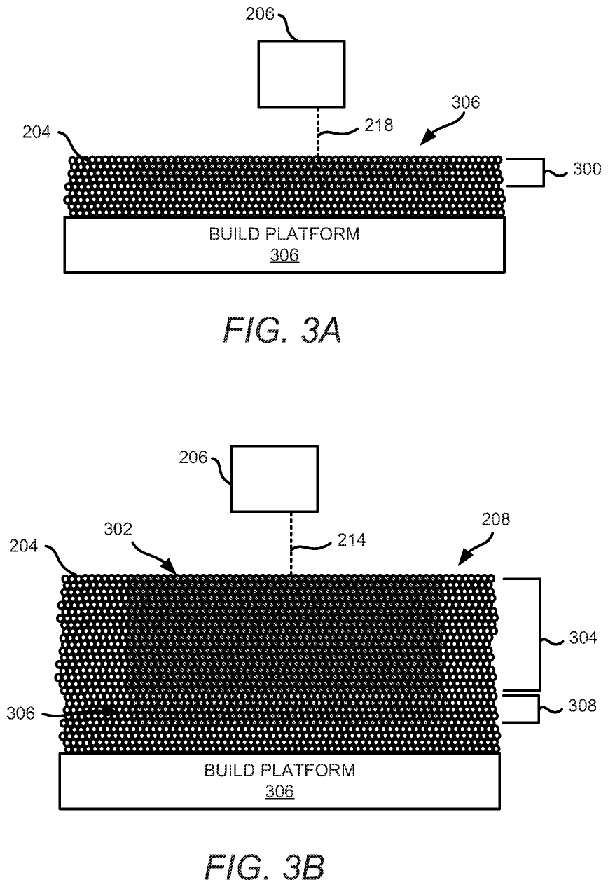

Reference is first made to FIGS. 1, 2, 3A and 3B. FIG. 1 shows a block diagram of an example apparatus 100 that may generate first print control data for defining a 3D part using a binding liquid including a binder and second print control data for defining a part enhancement section using a non-binding liquid. FIG. 2 shows an example 3D fabrication system 200 that may define the 3D part according to the first print control data and may define the part enhancement section according to the second print control data. FIGS. 3A and 3B, respectively, depict cross-sectional side views of a build volume of the 3D fabrication system 200 depicted in FIG. 2 during two example states in the defining of a part enhancement section and the fabrication of a 3D part. It should be understood that the example apparatus 100 depicted in FIG. 1, the 3D fabrication system 200, and/or the example various stages depicted in FIGS. 3A and 3B may include additional features and that some of the features described herein may be removed and/or modified without departing from the scopes of the features depicted in those figures.

The apparatus 100 depicted in FIG. 1 may be a computing system such as a server, a laptop computer, a tablet computer, a desktop computer, or the like. As shown, the apparatus 100 may include a processor 102, which may be a semiconductor-based microprocessor, a central processing unit (CPU), an application specific integrated circuit (ASIC), a field-programmable gate array (FPGA), and/or other suitable hardware device. In other examples, the apparatus 100 may be a 3D fabrication system, a 3D printer, a 3D fabricator, or the like. In these examples, the apparatus 100 may be equivalent to the 3D fabrication system 200 depicted in FIG. 2 and thus common features are depicted in both FIGS. 1 and 2. In other examples, the apparatus 100 may be separate from the 3D fabrication system 200 and may communicate instructions to the 3D fabrication system 200 to define a part 302 and to define a part enhancement section 306.

The apparatus 100 may also include a memory 110 that may have stored thereon machine-readable instructions (which may equivalently be termed computer-readable instructions) that the processor 102 may execute. The memory 110 may be an electronic, magnetic, optical, or other physical storage device that contains or stores executable instructions. The memory 110 may be, for example, Random-Access memory (RAM), an Electrically Erasable Programmable Read-Only Memory (EEPROM), a storage device, an optical disc, and the like. The memory 110, which may also be referred to as a computer-readable storage medium, may be a non-transitory machine-readable storage medium, where the term “non-transitory” does not encompass transitory propagating signals.

As shown in FIG. 1, the memory 110 may have stored thereon machine-readable instructions 112-118 that the processor 102 may execute. Although the instructions 112-118 are described herein as being stored on the memory 110 and may thus include a set of machine-readable instructions, the apparatus 100 may include hardware logic blocks that may perform functions similar to the instructions 112-118. For instance, the processor 102 may include hardware components that may execute the instructions 112-118. In other examples, the apparatus 100 may include a combination of instructions and hardware logic blocks to implement or execute functions corresponding to the instructions 112-118. In any of these examples, the processor 102 may implement the hardware logic blocks and/or execute the instructions 112-118. As discussed herein, the apparatus 100 may also include additional instructions and/or hardware logic blocks such that the processor 102 may execute operations in addition to or in place of those discussed above with respect to FIG. 1.

With reference to FIGS. 1, 2, 3A, and 3B, the processor 102 may execute the instructions 112 to access a model 202 of a part 302 to be defined. The processor 102 may access the model 202, which may be a digital file, e.g., a computer aided design (CAD) file, or other digital representation, that may define properties of the part 302 to be defined within the build volume 208 during a 3D fabrication operation. The model 202 may identify features of the part 302, such as the shape, the size, the color, the texture, mechanical property, and/or the like, of the part 302. The processor 102 may access the model 202 from a data store (not shown) or some other source, e.g., directly from a user, from an online source, etc. In addition, the processor 102 may process the model 202 to determine how fabrication components 206 of a 3D fabrication system (e.g., the 3D fabrication system 200) are to be operated to define the part 302 from build material particles 204. For instance, the processor 102 may process the model 202 in a printing pipeline, in which the output of the printing pipeline may be used to control the components in the 3D fabrication system 200 to define the part 302.

The processor 102 may process the model 202 to determine how the fabrication components 206 are to be operated to define the part 302 from layers of build material particles 204 in a build volume 208 of the 3D fabrication system 200. This may include determining in which build material layers 210 within the build volume 208 sections of the part 302 are to be defined as well as the areas in each of those build material layers 210 at which the sections of the part 302 are to be defined. Thus, for instance, the processor 102 may determine the build material layers 210 within the build volume 208 at which the part 302 is to be defined as well as the pattern of a bottom portion of the part 302 to be defined in those build material layers 210.

The processor 102 may execute the instructions 114 to generate, from the model 202, first print control data 212 corresponding to selected areas in the build material layers 210 (which may be an upper set of layers 304 as discussed herein) of build material particles 204 in a build volume 208 at which sections of the part 302 are to be defined. The processor 102 may generate the first print control data 212 based on the processing of the model 202 as discussed herein. Thus, for instance, the processor 102 may generate the first print control data 212 to include instructions to deposit a binding liquid 214 onto the areas in the identified build material layers 210 at which sections of the part 302 are to be defined. As shown in FIG. 3B, the part 302 may be defined in an upper set of layers 304 of the build material layers 210 in the build volume 208. The areas in the identified build material layers 210 upon which the binding liquid 214 are deposited may define the sections of the part 302.

According to examples, the build material particles 204 may have sizes that may range anywhere between about 1 micron to about 100 microns. In other examples, the build material particles 204 may have dimensions that are anywhere generally between about 30 μm and about 60 μm. In addition, the build material particles 204 may be a metal or a metal alloy that, when sintered, may coalesce and become a continuous metal part. Suitable metal powders, metal alloy powders, or mixtures of different metal powders, may include, but not limited to, stainless steel alloys 303, 304L, 310, 316L, 321, 347, 410, 420, 430, 440, 13-8PH, 17-4PH; low carbon steel and tool steel alloys, magnetic alloys including, but not limited to, Fe/Ni, Fe/Si, Fe/Al, Fe/Si/Al, Fe/Co, Fe/CoN; cobalt alloys including, but not limited to as well as other ferrous metal alloys, copper, copper alloys, bronze (Cu/Sn), brass (Cu/Zn), tin, lead, gold, silver, platinum, palladium, iridium, titanium, tantalum, iron, aluminum alloys, magnesium alloys, iron alloys, nickel alloys, chromium alloys, silicon alloys, zirconium alloys, gold alloys, and any appropriate combinations thereof.

The binding liquid 214 may include a binder that is to bind the build material particles 204 on which the binding liquid 214 has been deposited. The binder may be any suitable material that may physically bind the metallic build material particles 204 together. For instance, the binder may be a water-based binder containing dispersed polymer, e.g., latex, particles. In these examples, when the temperature of the binding liquid 214 is heated to a certain elevated temperature, the binder may coalesce and may thus cause the metallic build material particles 204 upon which the binding liquid 214 has been deposited to bind together. In other examples, the binder may include other types of binders that may, for instance, be activated through receipt of light, such as UV light. The part 302 at this stage of fabrication may be termed a green part and a later stage of fabrication may include a debinding and/or sintering operation to finish the fabrication of the part 302.

The binding liquid 214 may include water to reduce viscosity and increase jettability of the binding liquid 214. The binding liquid 214 may also include additives to improve jettability, such as, surfactants, humectants, co-solvents, etc. The binding liquid 214 may further include other additives, such as a biocide, an anti-kogation agent, and/or the like. In some examples, the temperature of the binding liquid 214 may be heated to the certain elevated temperature as discussed herein to cause the water and the other additives to evaporate while causing the binder in the binding liquid 214 to coalesce.

According to examples, the fabrication components 206 may include a liquid delivery system 216 that is to deliver the binding liquid 214. The liquid delivery system 216 may deliver the binding liquid 214 as droplets, which are represented as dashed lines, onto the build material layers 210. By way of particular example, the liquid delivery system 216 may be a printhead (or multiple printheads) having a plurality of nozzles in which droplet ejectors, e.g., resistors, piezoelectric actuators, and/or the like, may be provided to eject droplets of the binding liquid 214 through the nozzles.

It has been found that in some instances, when a liquid, such as the binding liquid 214, is deposited through jetting onto dry powder, such as dry build material particles 204, surface irregularities may occur. After the liquid is deposited onto a first few layers to define the part 302, powder wetting interactions may become less erratic and the number of surface irregularities may diminish in additional layers upon which the liquid is deposited. This may occur due to interactions caused by the liquid deposited in the first few layers with the liquid deposited in the additional layers.

As a result, the first few build material layers 210 at which sections of the part 302 may be fabricated may have surface irregularities as the initial build material layers 210 are normally dry or nearly dry when the binding liquid 214 is applied to those layers while the subsequent layers may not have the irregularities. The surface irregularities may become especially pronounced at high printed fluid flux densities when jetted drops land onto a dry build material layer 210 at close proximities to each other. This may be because the jetted drops that are in close proximity to each other may start merging into shallow pools on the surface of the build material layer 210. The longer it takes for the liquid to start wetting the build material particles 204 and infiltrate between the build material particles 204, the more likely it is that the shallow pools will form into larger individual droplets. As the droplets are formed, surface adhesive forces between the droplets and the build material particles 204 may cause the positions of some of the build material particles 204 to shift. This shift may cause formations of peaks (particles randomly driven together and agglomerated by beading liquid) and valleys (spaces between the agglomerated particles) in the build material layer 210.

As discussed herein, and according to examples of the present disclosure, to reduce or prevent the formation of the surface irregularities in the bottom section of the part 302, a part enhancement section 306 may be defined in some of the build material layers 210 that are beneath, e.g., within a predefined distance below, the upper set of layers 304 at which the part 302 is to be defined. The predefined distance may be a certain number of build material layers 210, which may include no layers, and may be sufficiently small to cause a reduction or elimination of the surface irregularities in the bottom of the part 302. The predefined distance may be based on the type of build material particles 204, the type of liquids being deposited, environmental conditions, and/or the like, and may be determined through testing.

As shown in FIGS. 3A and 3B, the part enhancement section 306 may be defined in a lower set of layers 308 and a bottom section of the part 302 may be defined in the upper set of layers 304 above the lower set of layers 308 in the build volume 208. As also discussed herein, the part enhancement section 306 may be defined through deposition of a non-binding liquid 218 onto the lower set of layers 308, in which the non-binding liquid 218 that does not include a binder that is to bind the build material particles 204 upon which the non-binding liquid 218 has been applied. As the non-binding liquid 218 does not include a binder, the non-binding liquid 218 may not cause the build material particles 204 in the part enhancement section 306 to bind together, e.g., when the temperature of the non-binding liquid 218 is elevated to a certain temperature to cause the binder in the binding liquid 214 to coalesce, when the temperature of the non-binding liquid 218 is raised to the certain temperature, when UV light is applied to the non-binding liquid 218, and/or the like. That is, for instance, the non-binding liquid 218 may not cause the build material particles 204 in the part enhancement section 306 to bind together as UV light and/or heat is applied to cause the non-binding liquid 218 to evaporate.

The non-binding liquid 218 may include the other liquids that the binding liquid 214 includes, such as water, surfactants, humectants, co-solvents, a biocide, an anti-kogation agent, and/or the like. As such, for instance, the non-binding liquid 218 deposited onto the lower set of layers 308 may evaporate either partially or entirely when heat is applied to elevate the temperature of the non-binding liquid 218 to the certain temperature to cause the binder in the binding liquid 214 to coalesce. In one regard, therefore, the build material particles 204 upon which the non-binding liquid 218 was deposited to define the part enhancement section 306, may be recycled, e.g., used again in another fabrication operation, following the evaporation of the non-binding liquid 218 as the non-binding liquid 218 does not include a binder.

The processor 102 may execute the instructions 116 to determine areas in the lower set of layers 308 of build material particles 204 in the build volume 208 at which sections of the part enhancement section 306 are to be defined, in which the areas in the lower set of layers 308 are based on the areas in the upper set of layers 304 of build material particles 204 at which the sections of the part 302 are to be defined. The areas in the lower set of layers 308 may correspond to, e.g., match, the areas in the bottom portion of the upper set of layers 304 at which a section of the part 302 is to be defined. That is, the areas in the lower set of layers 308 may have the same pattern as the bottom section of the part 302. As a result, the areas in which the binding liquid 214 is to be applied may be above, and in some examples, immediately above, areas in which the non-binding liquid 218 has been applied, which may reduce or prevent surface irregularities in the bottom section of the part 302 as discussed herein.

The processor 102 may execute the instructions 118 to generate second print control data 220 corresponding to the determined areas in the lower set of layers 308 of build material particles 204. The second print control data 220 may include instructions to deposit the non-binding liquid 218, which does not include a binder. That is, the non-binding liquid 218 does not include a binder that is to bind the build material particles 204 on which the non-binding liquid 218 is deposited. The non-binding liquid 218 therefore does not include the binder that is included in the binding liquid 214. In some examples, the processor 102 may generate the second print control data 220 to include instructions for the defining of multiple part enhancement sections 306 beneath multiple sections of the part 302. Thus, for instance, in an example in which the part 302 includes bottom sections on multiple levels, the multiple part enhancement sections 306 may be defined for the bottom sections on the multiple levels. In addition, some of the lower set of layers 308 for a part enhancement section 306 may overlap with some of the higher set of layers 304 for portions of a part 302 such that sections of the part enhancement section 306 and sections of the part 302 may be defined in the same set of layers.

Although particular reference is made herein to a first print control data and a second print control data, it should be understood that the first print control data and the second print control data may be the same or a common print control data such that, for instance, the first print control data and the second print control data may be part of or include the same set of instructions. That is, for instance, the processor 102 may generate print control data that includes both the first print control data and the second print control data.

According to examples, the processor 102 may generate the first print control data 212 to cause the upper set of layers 304 to be directly adjacent to and above the lower set of layers 308 as shown in FIG. 3B. In other examples, the processor 102 may generate the first print control data 212 to cause the upper set of layers 304 to be spaced from the upper set of layers 304. In these examples, the processor 102 may generate third print control data (not shown) that may include instructions for an intermediate set of layers (not shown) of build material particles 204 to be formed between the lower set of layers 308 and the upper set of layers 304, in which the intermediate set of layers are to be free of the binding liquid 214 and the non-binding liquid 218. That is, the third print control data may not include instructions for the binding liquid 214 or the non-binding liquid 218 to be deposited onto the layers in the intermediate set of layers.

According to examples, the processor 102 may generate an energy source control data 222 including instructions for an energy source 224 to apply energy onto the upper set of layers 304 and the lower set of layers 308 after the binding liquid 214 and the non-binding liquid 218 are respectively delivered to the layers in the upper set of layers 304 and the lower set of layers 308 to cause the build material particles 204 in the lower set of layers 308 to bind together. That is, the processor 102 may generate the energy source control data 222 to include instructions for the energy source 224 to apply the energy into the build volume 208 after the sections of the part 302 are defined in the upper set of layers 304. In other words, the energy source control data 222 may not include an instruction for the energy source 224 to apply energy between when instructions in the second print control data 220 are executed and instructions in the first print control data 212 are executed. The energy source 224 may be any suitable type of energy source 224, such as a resistive heater, a UV light source, and/or the like. In some examples, the energy source control data 222 may include instructions for the energy source 224 to apply energy. e.g., UV light, onto the build material layers 210 prior to, during, and/or following application of binding liquid 214 and/or non-binding liquid 218 and prior to the formation of respective subsequent build material layers 210 such that, for instance, the liquid in the binding liquid 214 and/or non-binding liquid 218 may partially or completely be evaporated prior to the formation of the respective subsequent build material layers 210.

In addition, the non-binding liquid 218 may include a composition that is to cause the non-binding liquid 218 to evaporate during application of the energy to activate the binder in the binding liquid 214 being applied to the lower set of layers 308 and the upper set of layers 304. The composition may include selected concentrations of water and additives that may fully or nearly fully evaporate during application of the energy. The selected concentrations may be determined through testing of various concentrations and application of various energy levels and durations.

In some examples, the liquid delivery system 216 in the fabrication components 206 may include a delivery device 226 that may deliver both the binding liquid 214 and the non-binding liquid 218. In these examples, the processor 102 may generate the first print control data 212 and the second print control data 220 to include instructions for the delivery device 226 to deliver both the binding liquid 214 and the non-binding liquid 218. The binding liquid 214 including the binder may be stored separately from the non-binding liquid 218 (i.e., does not include the binder) and the delivery device 226 may access the stored liquids independently. In other examples, the fabrication components 206 may include a binder supply, in which the delivery device 226 may selectively add the binder to the binding liquid 214 when the binding liquid 214 is delivered and may not add the binder to the non-binding liquid 218 when the non-binding liquid 218 is delivered.

In other examples, the liquid delivery system 216 may include a first delivery device 226 and a second delivery device 228. In these examples, the processor 102 may generate the first print control data 212 to include instructions for the first delivery device 226 to deliver the binding liquid 214 and the second print control data 220 to include instructions for the second delivery device 228 to deliver the non-binding liquid 218. In any of these examples, the first delivery device 226 and the second delivery device 228 may be printheads having nozzles through which the binding liquid 214 and the non-binding liquid 218 may be ejected as drops as the liquid delivery system 216 is scanned across the build platform 232.

With particular reference to FIG. 2, the 3D fabrication system 200 may also include a recoater 230, which may spread, spray, or otherwise define the build material particles 204 into a build material layer 210 as the recoater 230 is moved, e.g., scanned, across a build platform 232 as indicated by the arrow 234. The build platform 232 may provide the build volume 208 for the build material particles 204 to be spread into successive layers 210 of build material particles 204. The build platform 232 may be movable in a direction away from the recoater 230 during formation of successive build material layers 210.

According to examples, the 3D fabrication system 200 may include a deck 236 or multiple decks 236, 238 from which build material particles 204 may be supplied for formation into the build material layers 210. For instance, the deck 236 may supply an amount of build material particles 204 on top of the deck 236 that the recoater 230 may push over the build platform 232 as the recoater 230 is moved across the build platform 232 as denoted by the arrow 234 to form a build material layer 210 on the build platform 232 or on a previously formed build material layer 210.

The processor 102 may control operations of the recoater 230 via, for instance, the generation and implementation of recoater control data (not shown). In other examples, however, the 3D fabrication system 200 may include a separate controller (not shown) that may control operations of the recoater 230 in which the processor 102 may communicate with the controller. The processor 102 and/or another controller (not shown) may control other components of the 3D fabrication system 200 using the print control data 212, 220 and the energy source control data 222.

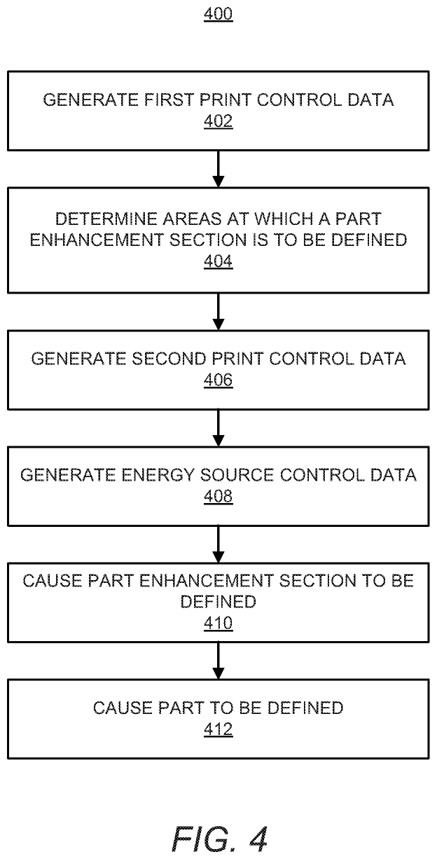

Various manners in which the processor 102 may operate are discussed in greater detail with respect to the method 400 depicted in FIG. 4. Particularly, FIG. 4 depicts a flow diagram of an example method 400 for generating first print control data 212 for defining a 3D part 302 using a binding liquid 214 including a binder and second print control data 220 for defining a part enhancement section 306 using a non-binding liquid 218 that does not include a binder. It should be understood that the method 400 depicted in FIG. 4 may include additional operations and that some of the operations described therein may be removed and/or modified without departing from scope of the method 400. The description of the method 400 is made with reference to the features depicted in FIGS. 1-3B for purposes of illustration.

At block 402, the processor 102 may generate first print control data 212 corresponding to selected areas in an upper set of layers 304 of build material particles 204 in a build volume 208 at which sections of a part 302 are to be defined based on a model of the part 302. The first print control data 212 may include instructions to deposit a binding liquid 214 including a binder that is to bind the build material particles 204 on which the binding liquid 214 is deposited. As discussed herein, the first print control data 212 may be used to control a liquid delivery system 216 to deliver the binding liquid 214 onto layers of the upper set of layers 304 to define the part 302.

At block 404, the processor 102 may determine areas in a lower set of layers 308 of build material particles 204 in the build volume 208 at which sections of a part enhancement section 306 are to be defined. The lower set of layers 308 may be within a predefined distance below the upper set of layers 304 and the areas in the lower set of layers 308 may have a pattern that matches a pattern on a bottom area of the part 302.

At block 406, the processor 102 may generate second print control data 220 corresponding to the determined areas in the lower set of layers 308 at which sections of the part enhancement section 306 are to be defined. The second print control data 220 may include instructions to deposit a non-binding liquid 218 that does not include the binder. As discussed herein, the second print control data 220 may be used to control a liquid delivery system 216 to deliver the non-binding liquid 218 onto layers of the lower set of layers 308 to define the part enhancement section 306.

At block 408, the processor 102 may generate an energy source control data 222 including instructions for an energy source 224 to apply energy onto the lower set of layers 308 and the upper set of layers 304 after the non-binding liquid 218 and the binding liquid 214 are respectively delivered to the layers in the lower set of layers 308 and the layers in the upper set of layers 304. The energy source 224 is to apply energy to cause the build material particles 204 in the upper set of layers 304 to bind together.

At block 410, the processor 102 may cause the part enhancement section 306 to be defined in the lower set of layers 308 through execution of the second print control data 220. As discussed herein, the processor 102 or a separate controller of the 3D fabrication system 200 may cause the fabrication components 206 to deliver the non-binding liquid 218, which does not include a binder, onto the layers in the lower set of layers 308 according to the second print control data 220.

At block 412, the processor 102 may cause the part 302 to be defined in the upper set of layers 304 through execution of the first print control data 212. As discussed herein, the processor 102 or the separate controller may cause the fabrication components 206 to deliver the binding liquid 214, which includes a binder, onto the layers in the upper set of layers 304 according to the first print control data 212. In addition, the processor 102 or the separate controller may execute the energy source control data 222 to cause the energy source 224 to apply energy onto the build volume 208 to cause the build material particles 204 defining the part 302 to bind together. As discussed herein, application of the energy may cause the liquids in the binding liquid 214 and the non-binding liquid 218 to evaporate and the binder in the binding liquid 214 to coalesce.

Following execution of the method 400, the part 302 may be removed from the build volume 208 and excess build material particles 204 may be removed from the part 302. The part 302 may also undergo additional finishing operations, such as sintering. Additionally, as the non-binding liquid 218 deposited to define the part enhancement section 306 may have fully or nearly fully evaporated, the build material particles 204 in that section may be recycled for use in another fabrication operation.

As discussed herein, the upper set of layers 304 may be immediately above the lower set of layers 308 as shown in FIG. 3B. In other examples, an intermediate layer or multiple intermediate layers may be provided between the upper set of layers 304 and the lower set of layers 308. In these examples, the processor 102 may generate third control data including instructions for the intermediate set of layers of build material particles 204 to be defined between the lower set of layers 308 and the upper set of layers 304, in which the intermediate set of layers are to be free of the binding liquid 214 and the non-binding liquid 218.

Some or all of the operations set forth in the method 400 may be included as utilities, programs, or subprograms, in any desired computer accessible medium. In addition, the method 400 may be embodied by computer programs, which may exist in a variety of forms both active and inactive. For example, they may exist as machine readable instructions, including source code, object code, executable code or other formats. Any of the above may be embodied on a non-transitory computer readable storage medium.

Examples of non-transitory computer readable storage media include computer system RAM, ROM, EPROM, EEPROM, and magnetic or optical disks or tapes. It is therefore to be understood that any electronic device capable of executing the above-described functions may perform those functions enumerated above.

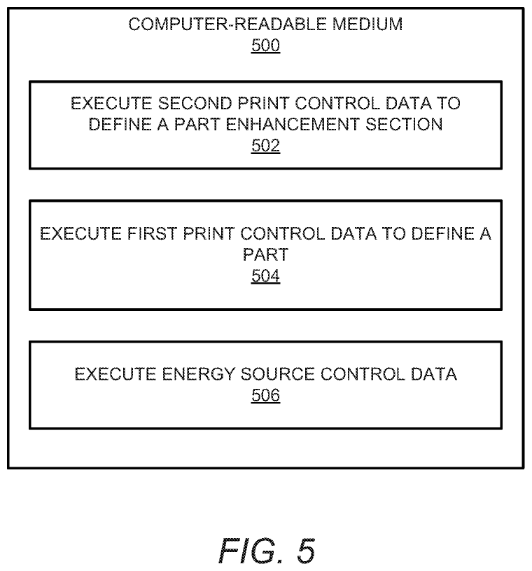

Turning now to FIG. 5, there is shown a block diagram of an example computer-readable medium 500 that may have stored thereon computer-readable instructions for generating first print control data 212 for defining a 3D part 302 using a binding liquid 214 including a binder and second print control data 220 for defining a part enhancement section 306 using a non-binding liquid 218 that does not include a binder. It should be understood that the example computer-readable medium 500 depicted in FIG. 5 may include additional instructions and that some of the instructions described herein may be removed and/or modified without departing from the scope of the computer-readable medium 500 disclosed herein. The computer-readable medium 500 may be a non-transitory computer-readable medium, in which the term “non-transitory” does not encompass transitory propagating signals. Additionally, FIG. 5 is described with reference to FIGS. 1-4 for purposes of illustration.

The computer-readable medium 500 may have stored thereon computer-readable instructions 502-506 that a processor, such as the processor 102 depicted in FIG. 1, may execute. The computer-readable medium 500 may be an electronic, magnetic, optical, or other physical storage device that contains or stores executable instructions. The computer-readable medium 500 may be, for example, Random Access memory (RAM), an Electrically Erasable Programmable Read-Only Memory (EEPROM), a storage device, an optical disc, and the like.

The processor may fetch, decode, and execute the instructions 502 to execute second print control data 220 to cause fabrication components 206 to selectively deliver a non-binding liquid 218 onto layers in a lower set of layers 308 of build material particles 204 to define a part enhancement section 306 in a build volume 208. The non-binding liquid 218 does not include a binder and thus does not bind the build material particles 204 onto which the non-binding liquid 218 has been delivered or after energy is applied to the non-binding liquid 218.

The processor may fetch, decode, and execute the instructions 504 to execute first print control data 212 to cause the fabrication components 206 to selectively deliver a binding liquid 214 onto layers in an upper set of layers 304 of build material particles 204. The upper set of layers 304 may be within a predefined distance above the lower set of layers 308 as discussed herein. The binding liquid 214 may also include a binder to bind the build material particles 204 onto which the binding liquid 214 has been deposited.

The processor may fetch, decode, and execute the instructions 506 to, following the selective delivery of the binding liquid 214 onto the layers in the upper set of layers 304, execute energy source control data 222 to cause the energy source 224 to apply energy to activate the binder in the binding liquid 214 delivered to the layers in the upper set of layers 304. As also discussed herein, the non-binding liquid 218 deposited onto the layers in the lower set of layers 308 may include a composition that is to cause the non-binding liquid 218 to evaporate responsive to the energy to activate the binder in the binding liquid 214 being applied to the lower set of layers 308 and the upper set of layers 304.

Although described specifically throughout the entirety of the instant disclosure, representative examples of the present disclosure have utility over a wide range of applications, and the above discussion is not intended and should not be construed to be limiting, but is offered as an illustrative discussion of aspects of the disclosure.

What has been described and illustrated herein is an example of the disclosure along with some of its variations. The terms, descriptions and figures used herein are set forth by way of illustration only and are not meant as limitations. Many variations are possible within the spirit and scope of the disclosure, which is intended to be defined by the following claims—and their equivalents—in which all terms are meant in their broadest reasonable sense unless otherwise indicated.

What is claimed is:

1. An apparatus comprising:
a processor; and
a memory on which is stored instructions that when executed by the processor cause the processor to:
access a model of a part to be defined;
generate, from the model, first print control data corresponding to selected areas in an upper set of layers of build material particles in a build volume at which a binding liquid is to be deposited to define sections of the part, wherein the first print control data includes instructions to deposit the binding liquid onto the selected areas, the binding liquid including a binder that is to bind the build material particles on which the binding liquid is deposited;
determine areas in a lower set of layers of build material particles in the build volume at which a non-binding liquid that does not include the binder to be deposited to define sections of a part enhancement section, the lower set of layers being within a predefined distance below the upper set of layers, wherein the areas in the lower set of layers are based on the areas in the upper set of layers of build material particles at which the sections of the part are to be defined; and
generate second print control data corresponding to the determined areas in the lower set of layers at which the non-binding liquid is to be deposited.

2. The apparatus of claim 1, wherein the instructions are further to cause the processor to:
generate the first print control data to cause a liquid delivery system of a three-dimensional (3D) fabrication system to deliver the binding liquid into a pattern onto the selected areas in the layers of the upper set of layers; and
generate the second print control data to cause the liquid delivery system to selectively deliver the non-binding liquid in a matching pattern onto the layers in the lower set of layers.

3. The apparatus of claim 1, wherein the instructions are to cause the processor to generate the first print control data to cause the upper set of layers to be directly adjacent to and above the lower set of layers.

4. The apparatus of claim 1, wherein the instructions are further to cause the processor to:
generate third print control data including instructions for an intermediate set of layers of build material particles to be defined between the lower set of layers and the upper set of layers, wherein the intermediate set of layers are to be free of the binding liquid and the non-binding liquid.

5. The apparatus of claim 1, wherein the instructions are further to cause the processor to:
generate an energy source control data including instructions for an energy source to apply energy onto the upper set of layers and the lower set of layers after the binding liquid and the non-binding liquid are respectively delivered to the layers in the upper set of layers and the lower set of layers to cause the build material particles in the upper set of layers to bind together.

6. The apparatus of claim 1, wherein the print control data includes instructions to define the sections of the part enhancement section without increasing a temperature of the build material particles defining the sections of the part enhancement section above a temperature of the build material particles prior to defining of the sections of the part enhancement section.

7. The apparatus of claim 1, wherein the first print control data and the second print control data include instructions for a delivery device to deliver the binding liquid to define the sections of the part and the non-binding liquid to define the sections of the part enhancement section.

8. The apparatus of claim 1, wherein the first print control data includes instructions for a first delivery device to deliver the binding liquid to define the sections of the part and the second print control data includes instructions for a second delivery device to deliver the non-binding liquid to define the sections of the part enhancement section.

9. A method comprising:
generating, by a processor, first print control data corresponding to selected areas in an upper set of layers of build material particles in a build volume at which sections of a part are to be defined based on a model of the part, wherein the first print control data includes instructions to deposit a binding liquid including a binder that is to bind the build material particles on which the binding liquid is deposited;
determining, by the processor, areas in a lower set of layers of build material particles in the build volume at which sections of a part enhancement section are to be defined, the lower set of layers being within a predefined distance below the upper set of layers, wherein the areas in the lower set of layers have a pattern that matches a pattern on a bottom area of the part; and
generating, by the processor, second print control data corresponding to the determined areas in the lower set of layers at which sections of the part enhancement section are to be defined, the second print control data including instructions to deposit a non-binding liquid that does not include the binder.

10. The method of claim 9, further comprising:
generating third print control data including instructions for an intermediate set of layers of build material particles to be defined between the lower set of layers and the upper set of layers, wherein the intermediate set of layers are to be free of the binding liquid and the non-binding liquid.

11. The method of claim 9, further comprising:
generating an energy source control data including instructions for an energy source to apply energy onto the lower set of layers and the upper set of layers after the non-binding liquid and the binding liquid are respectively delivered to the layers in the lower set of layers and the layers in the upper set of layers to cause the build material particles in the upper set of layers to bind together.

12. The method of claim 9, further comprising:
sending the second print control data to a three-dimensional (3D) fabrication system to cause the part enhancement section to be defined in the areas in the lower set of layers; and
sending the first print control data to the 3D fabrication system to cause the part to be defined in the selected areas in the upper set of layers.

13. The method of claim 9, further comprising:
controlling fabrication components of a three-dimensional (3D) fabrication system to define the part enhancement section in the areas in the lower set of layers according to the second print control data; and
controlling the fabrication components to define the part in the selected areas in the upper set of layers of build material particles in the build volume according to the first print control data.

14. A three-dimensional (3D) fabrication system comprising:
an energy source;
a build volume on a build platform;
fabrication components;
a processor; and
a non-transitory computer readable medium on which is stored instructions that when executed, cause the processor to:
execute second print control data to cause the fabrication components to selectively deliver a non-binding liquid onto layers in a lower set of layers of build material particles to define a part enhancement section in the build volume, wherein the non-binding liquid does not bind the build material particles onto which the non-binding liquid has been delivered;
execute first print control data to cause the fabrication components to selectively deliver a binding liquid onto layers in an upper set of layers of build material particles, the upper set of layers being within a predefined distance above the lower set of layers, and the binding liquid including a binder to bind the build material particles onto which the binding liquid has been delivered; and
following the selective delivery of the binding liquid onto the layers in the upper set of layers, execute energy source control data to cause the energy source to apply energy to activate the binder in the binding liquid delivered to the layers in the upper set of layers.

15. The 3D fabrication system of claim 14, wherein the non-binding liquid deposited onto the layers in the lower set of layers includes a composition that is to cause the non-binding liquid to evaporate responsive to the energy to activate the binder in the binding liquid being applied to the lower set of layers and the upper set of layers.
